(19) United States
(12) Patent Application Publication
(10) Pub. No.: US 2009/0200756 A1
(43) Pub. Date: Aug. 13, 2009

(54) Seal structure

(75) Inventor: Tomohiro Yamamoto, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/319,461

(22) Filed: Jan. 6, 2009

(30) Foreign Application Priority Data
Feb. 11, 2008 (JP) 2008-029832

(51) Int. Cl. F16J 15/06

(52) U.S. Cl. 277/616

(57) ABSTRACT

A seal structure is disclosed, wherein a casing 10 has an annular protrusion 11 making up a hole-formed portion of a through hole 12. The portion of a joint member 30 around a joint body 31 is wound with a band-shaped seal member 60. A first peripheral end portion 60a and a second peripheral end portion 60b of the seal member 60 are formed progressively upward in the direction from the engine compartment to the passenger compartment. In the process of inserting the joint body 31 and the seal member 60 into the through hole 12 of the casing 10, the first peripheral end portion 60a and the second peripheral end portion 60b of the seal member 60 are butted against each other in the peripheral direction. As a result, a gap is difficult to form between the first peripheral end portion 60a and the second peripheral end portion 60b.

### BACKGROUND OF THE INVENTION

1. Field of the Invention

This invention relates to a seal structure using a seal member.

2. Description of the Related Art

A conventional seal structure of this type includes a casing arranged between an engine compartment and a passenger compartment of an automotive vehicle, a joint member arranged in a hole formed through the casing and connected to a refrigerant pipe on the engine compartment side and a refrigerant pipe on the passenger compartment side, and a seal member arranged around the joint member to seal an existing gap between the joint member and a hole-formed portion of the casing having a through hole (for example, Japanese Unexamined Patent Publication No. 2005-324777).

### SUMMARY OF THE INVENTION

The present inventor has studied a structure based on the aforementioned seal structure in which a band-shaped seal member is wound around the joint member so that a first peripheral end portion and a second peripheral end portion of the seal member are brought into contact with each other in the direction along the through hole, and has found the problems described below.

Specifically, as shown in FIGS. 10A and 10B, assume that a seal member 1 is wound around a joint member 3, and the first peripheral end portion 1a and the second peripheral end portion 1b of the seal member 1 are brought into contact with each other along the direction of the through hole. At the time of inserting the joint member and the seal member into the through hole of the casing, the first peripheral end portion 1a and the second peripheral end portion 1b may be elastically deformed by being pushed in the directions of arrows a in FIG. 10C away from each other by the inner wall of the through hole of the casing.

For this reason, a gap 2a is formed between the first peripheral end portion 1a and the second peripheral end portion 1b. As a result, the sealing performance in the through hole of the casing is reduced, so that water is liable to intrude into the passenger compartment from the engine compartment by way of the through hole of the casing.

As shown in FIGS. 11A and 11B, a seal member 1 with the first peripheral side 1c of the seal member 1 bent has been conceived in which the first peripheral side 1c and the second peripheral side 1d are superposed on each other. In this case, as shown in FIG. 11C, the bent portion 1e of the first peripheral side 1c comes away from the joint member 3 thereby to form a gap 2b between the bent portion 1e and the second peripheral end portion 1b.

As a result, the sealing performance in the through hole of the casing is reduced and water may intrude into the passenger compartment from the engine compartment by way of the through hole of the casing.

In view of the problem set forth above, the object of this invention is to provide a seal structure for improving the sealing performance in the through hole of the casing.

In order to achieve the object described above, according to a first aspect of the invention, there is provided a seal structure comprising:

a casing (10, 80) having a through hole (12, 83b);

a joint member (30) arranged through the through hole (12, 83b) to connect a first air-conditioning unit (50, 53, 53a) inside the casing (10, 80) and a second air-conditioning unit (51, 52, 50a, 51a, 52a) outside the casing (10, 80) thereby forming a fluid path between the first and second air-conditioning units; and

a band-shaped seal member (60) wound around the joint member (30) to seal a gap between the joint member (30) and a hole-formed portion (11, 83a) of the through hole (12, 83b) of the casing (10, 80);

wherein a first peripheral end portion (60a) and a second peripheral end portion (60b) of the seal member (60) are arranged in peripheral contact with each other;

wherein the seal member (60) is formed in such a manner that the first peripheral end portion (60a) and the second peripheral end portion (60b) are in contact with each other along a first diagonal direction extending progressively upward along one direction of the through hole (12, 83b); and

wherein the joint member (30) and the seal member (60) are inserted in the through hole (12, 83b) in such a manner that the first peripheral end portion (60a) and the second peripheral end portion (60b) are butted against each other.

As described above, the first peripheral end portion and the second peripheral end portion of the seal member are butted with each other, and therefore a gap is not easily formed between the first peripheral end portion and the second peripheral end portion. As a result, the sealing performance in the through hole of the casing is improved.

As described above, the seal member is formed with the first peripheral end portion and the second peripheral end portion in contact with each other along the first diagonal direction extending progressively upward along the one direction of the through hole.

Therefore, even in the case where water intrudes between the first peripheral end portion and the second peripheral end portion, the particular water is prevented from entering along the one direction of the through hole between the first peripheral end portion and the second peripheral end portion.

According to a first aspect of the invention, there is provided a seal structure wherein the first peripheral end portion (60a) of the seal member (60) includes a first contact portion (601) in contact with the second peripheral end portion along a first diagonal direction and a second contact portion (600) in contact with the second peripheral end portion along a second diagonal direction extending progressively downward in the one direction of the through hole.

In the first aspect of the invention, the first peripheral end portion (60a) of the seal member (60) may have a plurality of the first contact portions (601) and a plurality of the second contact portions (600).

Further, the first peripheral end portion (60a) of the seal member (60) can be formed in such a manner that the first contact portions (601) and the second contact portions (600) are arranged alternately with each other.

According to a second aspect of the invention, there is provided a seal structure comprising:

a casing (10, 80) having a through hole (12, 83b);

a joint member (30) arranged through the through hole (12, 83b) to connect a first air-conditioning unit (50, 53, 53a) inside the casing (10, 80) and a second air-conditioning unit (51, 52, 50a, 51a, 52a) outside the casing (10, 80) thereby to form a fluid path between the first and second air-conditioning units; and

a band-shaped seal member (60) wound around the joint member (30) to seal a gap between the joint member (30) and the hole-formed portion (11, 83a) of the through hole (12, 83b) of the casing (10, 80);

wherein a first peripheral end portion (100a) and a second peripheral end portion (100b) of the seal member (60) are arranged in contact with each other in the peripheral direction;

wherein the first peripheral end portion (100a) of the seal member (60) is formed with a convex arc in the peripheral direction;

wherein the second peripheral end portion (100b) of the seal member (60) are formed with a concave arc in the peripheral direction so that the first peripheral end portion (100a) is fitted therein; and

wherein the joint member (30) and the seal member (60) are inserted into the through hole (83b) in such a manner that the first peripheral end portion (100b) and the second peripheral end portion (10a) are butted against each other.

As described above, the first peripheral end portion and the second peripheral end portion of the seal member are butted against each other, and therefore a gap is not easily formed between the first peripheral end portion and the second peripheral end portion of the seal member. As a result, the sealing performance in the through hole of the casing is improved.

Furthermore, as described above, the first peripheral end portion is formed with a convex arc in the peripheral direction, while the second peripheral end portion is formed with a concave arc. Even in the case where the water intrudes between the first peripheral end portion and the second peripheral end portion, the particular water is prevented from entering along the one direction of the through hole between the first peripheral end portion and the second peripheral end portion.

In the second aspect of the invention, the first peripheral end portion (100a) of the seal member (60) may be formed in such a manner as to be protruded semicircularly toward the second peripheral end portion (100b).

In the second aspect of the invention, the casing (10) may be arranged in the through hole (21) formed in a fire wall of the vehicle between the engine compartment and the passenger compartment.

In the second aspect of the invention, the casing (10) may constitute an air-conditioning casing in which the heat exchanger forming the first air-conditioning unit (53a) is accommodated and through which the air flow that has exchanged heat in the heat exchanger flows.

The reference numeral in the parenthesis indicating each means described in the claims and the forgoing section represents the correspondence with a specific means of the embodiments described later.

The present invention may be more fully understood from the description of preferred embodiments of the invention, as set forth below, together with the accompanying drawings.

### BRIEF DESCRIPTION OF THE DRAWINGS

FIG. 1 is a diagram showing the seal structure according to a first embodiment of the invention.

FIG. 2 is a view taken in the direction of arrow C in FIG. 1.

FIG. 3A is a diagram showing the seal member as a unit in FIG. 1.

FIG. 3B is a view taken in the direction of arrow D in FIG. 3A.

FIG. 4 is a diagram showing the seal structure according to a second embodiment of the invention.

FIG. 5 is a view taken in the direction of arrow F in FIG. 4.

FIG. 6 is a partially enlarged view of FIG. 4.

FIG. 7 is a diagram showing the seal structure according to a third embodiment of the invention.

FIG. 8 is a diagram showing the seal structure according to a fourth embodiment of the invention.

FIG. 9 is a diagram showing the seal structure according to a fifth embodiment of the invention.

FIG. 10A is a diagram showing a seal structure.

FIG. 10B is a view taken in the direction of arrow A in FIG. 10A.

FIG. 10C is a view of the seal structure taken in the same direction as in FIG. 10B to explain deformation of the seal member.

FIG. 11A is a diagram showing the seal structure according to a comparative example.

FIG. 11B is a view taken in the direction of arrow B in FIG. 11A.

FIG. 11C is a view of a comparative example of the seal structure taken in the same direction as in FIG. 11B to explain deformation of a comparative example of the seal member.

### DESCRIPTION OF THE PREFERRED EMBODIMENTS

### First Embodiment

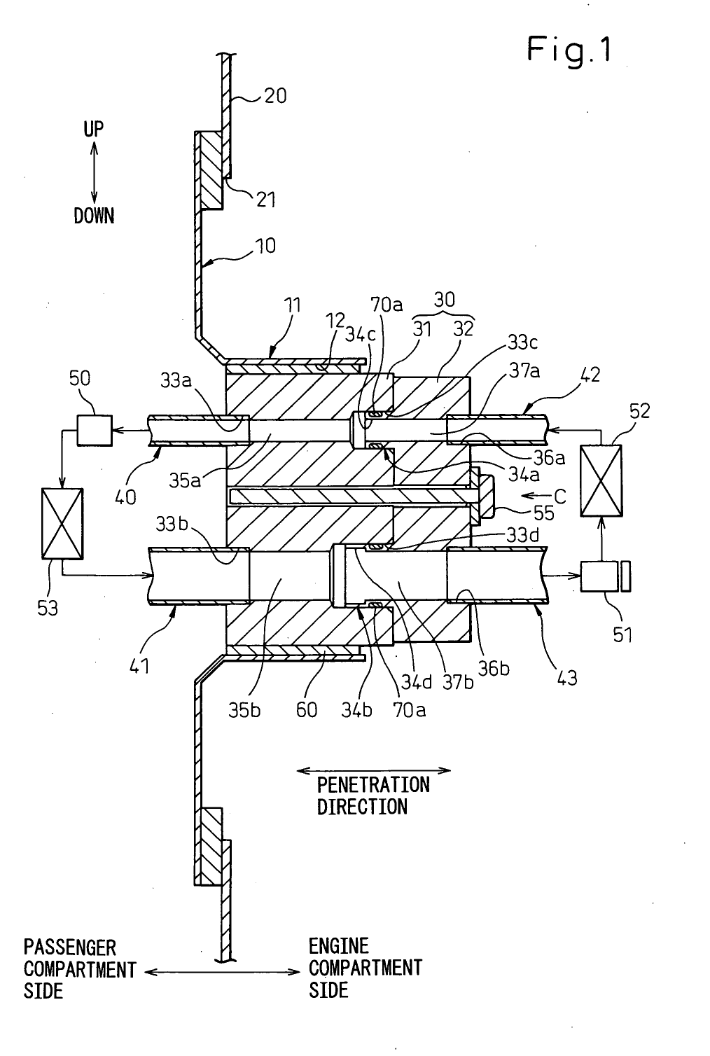

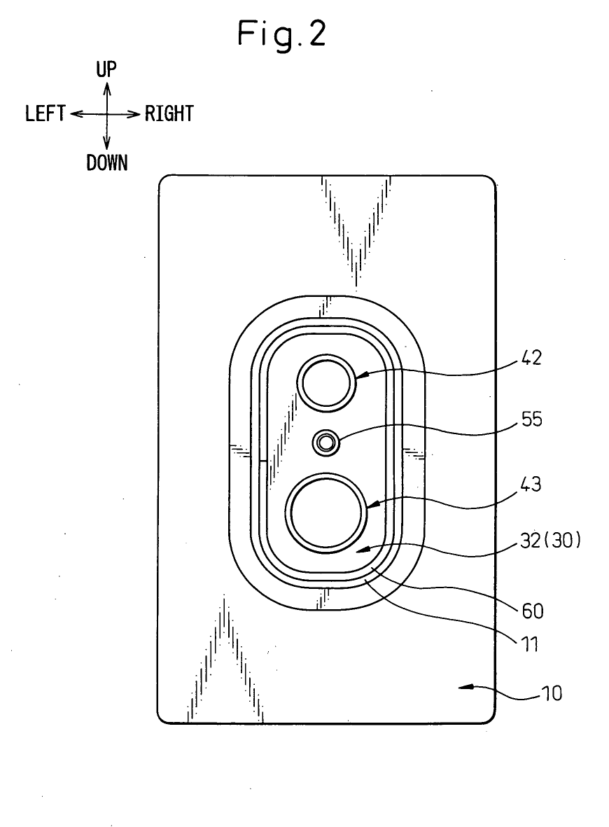

A seal structure according to a first embodiment of the invention as an application to an air conditioning system of an automotive vehicle is shown in FIG. 1, which is a view of the seal structure according to this embodiment taken along the width of the vehicle. FIG. 2 is a view taken in the direction of arrow C in FIG. 1.

A casing 10 is arranged in a through hole 21 of a fire wall 20 and supported on the fire wall 20. The fire wall 20 is arranged between a passenger compartment and an engine compartment.

The casing 10 has a protrusion 11 to the engine compartment side. The protrusion 11, as shown in FIG. 2, is formed annular and constitutes a hole-formed portion to form a through hole 12. The hole 12 is formed through between the passenger compartment and the engine compartment.

A joint member 30 is arranged in the through hole 12. The joint member 30 is composed of a joint body 31 and a flange portion 32. The joint body 31 is arranged on the passenger compartment side in the through hole 12. The flange portion 32 and the joint body 31 are fixed to each other by a bolt 55.

The joint body 31 is formed with holes 33a and 33b and holes 33c, 33d. A refrigerant path 35a is formed between the hole 33a and the hole 33c of the joint body 31. The refrigerant pipe 40 is coupled to the joint body 31 with the forward end portion of the refrigerant pipe 40 inserted in the hole 33a. The refrigerant pipe 40 is connected to an expansion valve 50.

A refrigerant path 35b is formed between the holes 33b and 33d. The refrigerant pipe 41 is coupled to the joint body 31 with the forward end portion of the refrigerant pipe 41 inserted into the hole 33b. The refrigerant pipe 41 is connected to an evaporator 53.

The evaporator 53 constitutes a well-known refrigeration cycle system together with the expansion valve 50, a compressor 51 and a condenser 52. The expansion valve 50 and the evaporator 53 constitute a first air-conditioning unit and are arranged on the passenger compartment. The compressor 51 and the condenser 52 constitute a second air-conditioning unit and are arranged in the engine compartment.

The flange portion 32 is arranged on the joint body 31 on the engine compartment side. The flange portion 32 has protrusions 34a and 34b formed toward the joint body 31.

The protrusion 34a has an opening 34c toward the joint body 31. The protrusion 34b has an opening 34d toward the joint body 31. The flange portion 32 has holes 36a and 36b open on the engine compartment.

A refrigerant path 37a is formed between the hole 36a and the opening 34c of the flange portion 32. A refrigerant path 37b is formed between the hole 36b and the opening 34d of the flange portion 32.

The hole 36a is connected with a refrigerant pipe 42. The refrigerant pipe 42 is connected to the condenser 52. The hole 36b is connected with a refrigerant pipe 43. The refrigerant pipe 43 is connected to the compressor 51.

The refrigerant path 35a and the refrigerant path 37a communicate with each other with the protrusion 34a of the flange portion 32 fitted in the hole 33c of the joint body 31. The refrigerant path 35b and the refrigerant path 37b communicate with each other with the protrusion 34b fitted in the hole 33d.

An O-ring 70a is mounted on the protrusion 34a. The O-ring 70a seals a gap between the protrusion 34a and the hole-formed portion having the hole 33c. The O-ring 70a is mounted on the protrusion 33b. The O-ring 70a seals a gap between the protrusion 34b and the inner wall of the hole 33d.

According to this embodiment, the flange portion 32 and the joint body 31 are each made of an aluminum alloy.

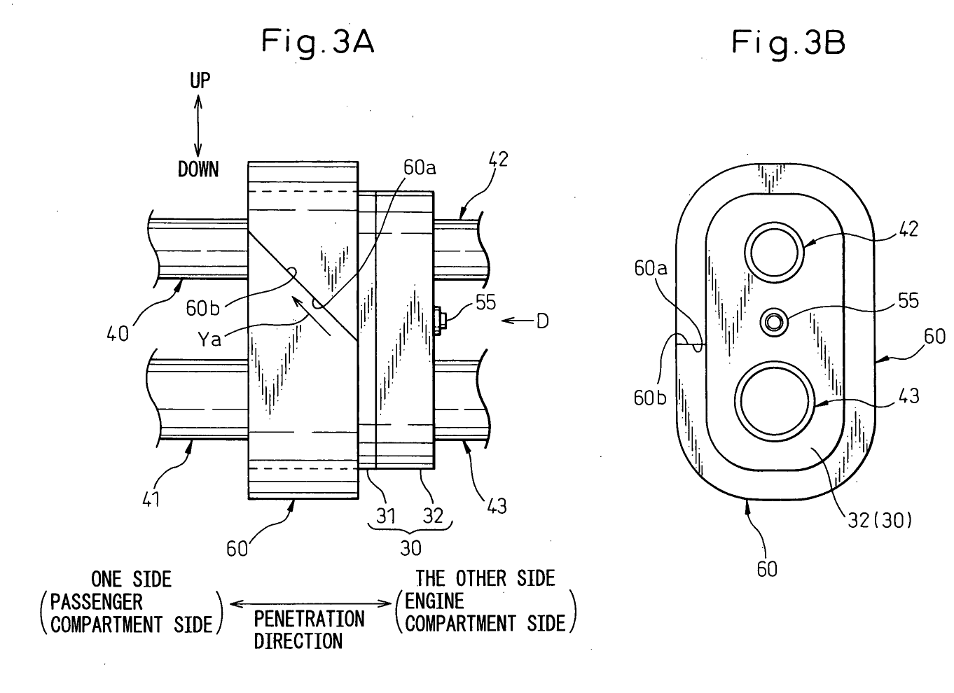

The portion of the joint member 30 around the joint body 31, as shown in FIGS. 3A and 3B, is wound with a band-shaped seal member 60. FIG. 3A is a view of the joint member 30 and the seal member 60 taken along the vehicle width, and FIG. 3B the view taken in the direction of arrow D in FIG. 3A.

The first peripheral end portion 60a and the second peripheral end portion 60b of the seal member 60 are in contact with each other in the peripheral direction. The first peripheral end portion 60a and the second peripheral end portion 60b are formed along the diagonal direction Ya (FIG. 3A) between the engine compartment and the passenger compartment. The diagonal direction Ya constitutes a first diagonal direction which is inclined upward as it approaches the passenger compartment in the penetration direction of the through hole 12. The passenger compartment side in the penetration direction of the through hole 12 corresponds to one direction of the through hole described in the appended claims.

Next, the manner in which the joint member 30 is assembled on the casing 10 according to this embodiment will be explained.

First, the seal member 60 is wound on the joint body 31. In the process, the seal member 60 is bonded to the joint body 31 with a double-faced adhesive tape. The first peripheral end portion 60a and the second peripheral end portion 60b of the seal member 60 are brought into contact with each other along the diagonal direction Ya.

Next, the joint body 31 and the seal member 60 are inserted into the through hole 12 of the casing 10. In the process, the seal member 60 is compressed by elastic deformation in the through hole 12 of the casing 10. In addition, the first peripheral end portion 60a and the second peripheral end portion 60b are butted against each other in the peripheral direction.

After that, the flange portion 32 is assembled on the joint body 31 and fixed on the joint body 31 with the bolt 55.

In the embodiment described above, the first peripheral end portion 60a and the second peripheral end portion 60b of the seal member 60 are formed progressively upward in the direction from the engine compartment to the passenger compartment.

Therefore, in the process of inserting the joint body 31 and the seal member 60 into the through hole 12 of the casing 10, the first peripheral end portion 60a and the second peripheral end portion 60b of the seal member 60 are butted against each other in the peripheral direction. As a result, any gap is not easily formed between the first peripheral end portion 60a and the second peripheral end portion 60b.

According to this embodiment, the first peripheral end portion 60a and the second peripheral end portion 60b of the seal member 60 are in peripheral contact with each other between the engine compartment and the passenger compartment. In addition, the first peripheral end portion 60a and the second peripheral end portion 60b are formed progressively upward in the direction from the engine compartment to the passenger compartment.

As a result, water which may intrude between the first peripheral end portion 60a and the second peripheral end portion 60b from the engine compartment is prevented from reaching the passenger compartment.

### Second Embodiment

Next, an explanation will be given about the seal structure according to a second embodiment of the invention as an application to an evaporator in the passenger compartment air-conditioning unit.

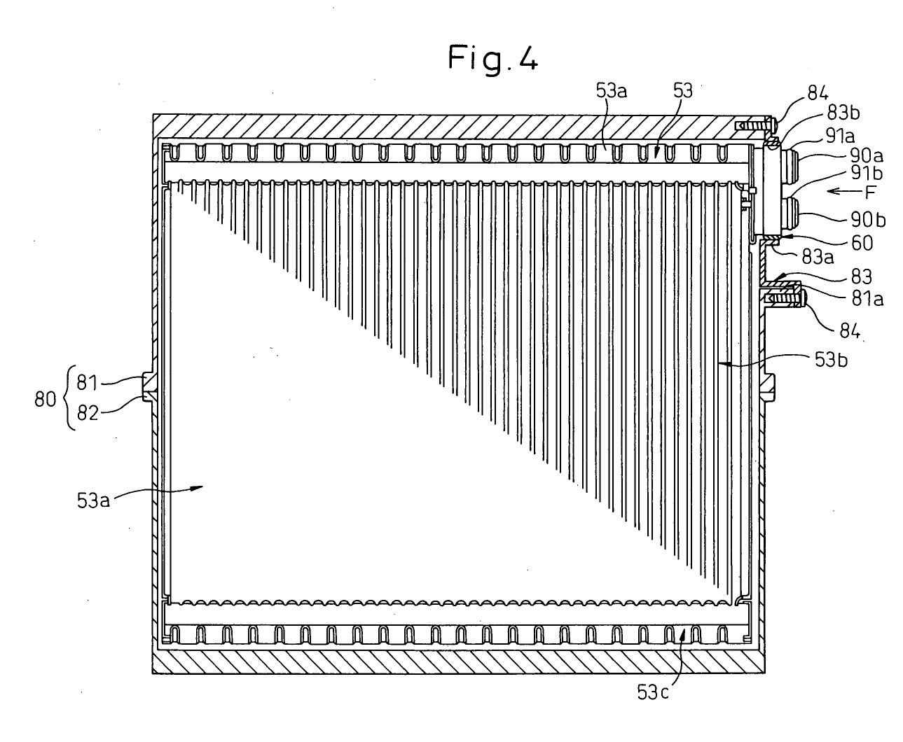

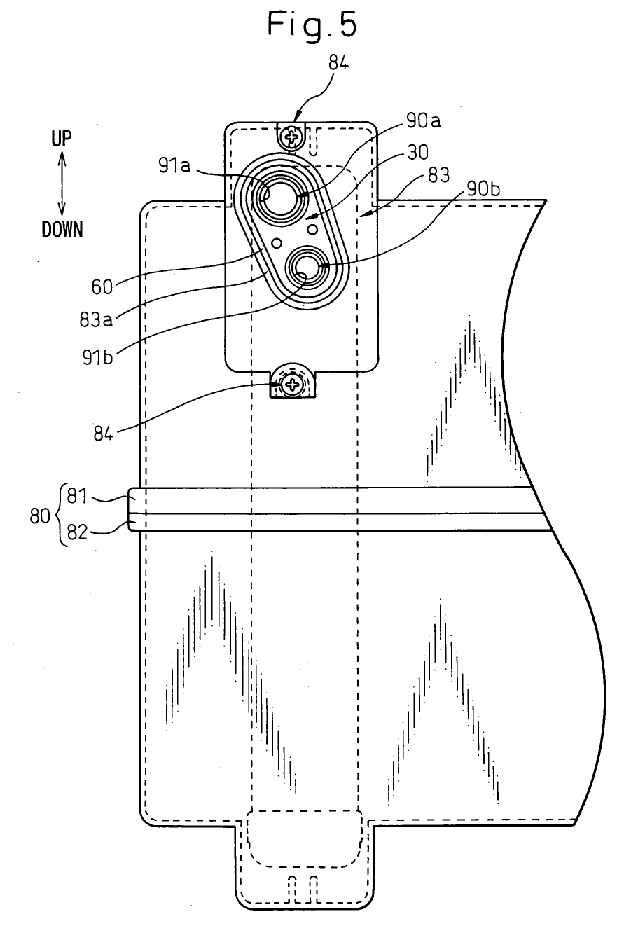

FIG. 4 is a diagram showing an evaporator 53a according to this embodiment, and FIG. 5 is a view taken in the direction of arrow F in FIG. 4.

The evaporator 53a is arranged in the air-conditioning casing 80. The air-conditioning casing 80 allows the air to flow through it to flow in the passenger compartment, and the evaporator 53a cools the air flowing through the air-conditioning casing 80 by evaporation of refrigerant.

The air-conditioning casing 80 comprises an upper casing 81 and a lower casing 82. The upper casing 81 is formed with a hole 81a. A lid 83 of the air-conditioning casing 80 is fitted in the hole 81a of the upper casing 81.

The lid 83 has a protrusion 83a formed outward of the air-conditioning casing 80. The protrusion 83a is formed in annular and makes up a hole-formed portion of the through hole 83b. The through hole 83b is formed through in and outside of the air-conditioning casing 80. The lid 83 is fixed by screws 84 on the upper casing 81.

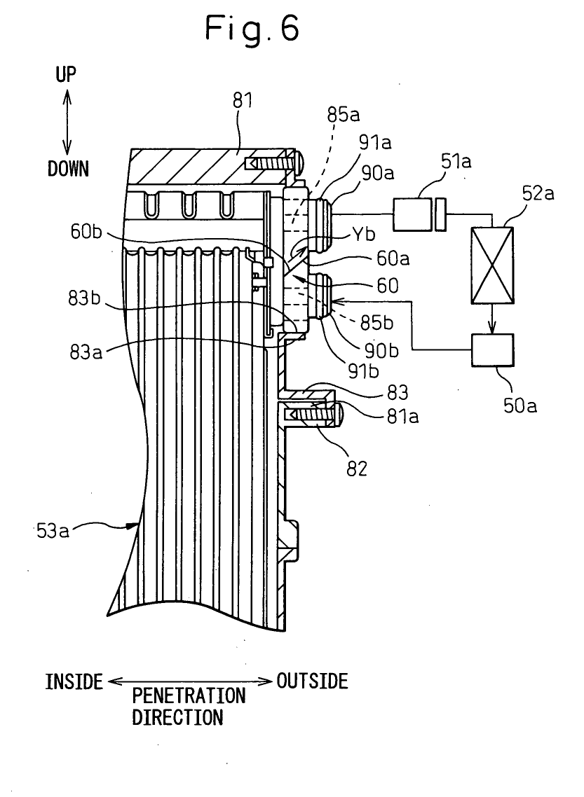

The joint member 30 is coupled to the lateral side of the evaporator 53a. The joint member 30 is arranged in the through hole 83b of the lid 83. FIG. 6 is an enlarged view of the parts around the joint member 30 in FIG. 4.

The joint member 30 has refrigerant paths 85a and 85b. The portion of the refrigerant path 85a inside the air-conditioning casing 80 is connected to the refrigerant inlet of the evaporator 53a. The portion of the refrigerant path 85b inside the air-conditioning casing 80 is connected to the refrigerant outlet of the evaporator 53a.

The joint member 30 is coupled with pipe fittings 90a and 90b. The pipe fittings 90a and 90b are projected outward of the air-conditioning casing 80 from the joint member 30.

The interior of the pipe fittings 90a communicates with the refrigerant path 85a. The pipe fittings 90a is connected with the expansion valve 50 through the refrigerant pipe. The interior of the pipe fittings 90b communicates with the refrigerant path 85b. The pipe fittings 90b is connected with the compressor 51.

According to this embodiment, the evaporator 53a constitutes a first air-conditioning unit, and the expansion valve 50a, the compressor 51a and the condenser 52a constitute a second air-conditioning unit.

Like in the first embodiment described above, the band-shaped seal member 60 is wound around the joint member 30. The first peripheral end portion 60a and the second peripheral end portion 60b of the seal member 60 are in contact with each other in the peripheral direction.

The first peripheral end portion 60a and the second peripheral end portion 60b are formed along the diagonal direction Yb (FIG. 6) between the inside of the air-conditioning casing 80 and the outside of the air-conditioning casing 80.

The diagonal direction Yb constitutes a first diagonal direction which is inclined upward as it approaches the outside of the air-conditioning casing 80 in the penetration direction of the through hole 83b. The outside of the air-conditioning casing 80 in the penetration direction of the through hole 83b corresponds to one direction of the through hole described in the appended claims.

Next, an explanation will be given concerning the manner in which the joint member 30 is assembled on the casing 80 according to this embodiment.

First, the band-shaped seal member 60 is bonded to the joint member 30 with a double-faced adhesive tape. Then, the first peripheral end portion 60a and the second peripheral end portion 60b of the seal member 60 are brought into peripheral contact with each other along the diagonal direction Yb.

Next, the joint member 30 and the seal member 60 are inserted into the through hole 83b of the lid 83. In the process, the seal member 60 is deformed in the through hole 83b of the lid 83 by elastic deformation. In addition, the first peripheral end portion 60a and the second peripheral end portion 60b are butted against each other in the peripheral direction.

After that, the lid 83 is fixed with screws 84 to the upper casing 81 of the air-conditioning casing 80.

According to this embodiment described above, the first peripheral end portion 60a and the second peripheral end portion 60b of the seal member 60 are formed progressively upward from inside the air-conditioning casing 80 to the outside.

Therefore, in the process of inserting the joint member 30 and the seal member 60 into the through hole 83b of the lid 83, the first peripheral end portion 60a and the second peripheral end portion 60b of the seal member 60 are butted against each other in the peripheral direction.

For this reason, a gap is difficult to form between the first peripheral end portion 60a and the second peripheral end portion 60b. As a result, the sealing performance is improved between the protrusion 83a of the lid 83 and the joint member 30.

According to this embodiment, the first peripheral end portion 60a and the second peripheral end portion 60b of the seal member 60 are in contact with each other in the peripheral direction between the inside and the outside of the air-conditioning casing 80.

In addition, the first peripheral end portion 60a and the second peripheral end portion 60b are formed progressively upward from the inside to the outside of the air-conditioning casing 80.

Even in the case where water intrudes into the gap between the first peripheral end portion 60a and the second peripheral end portion 60b from inside the air-conditioning casing 80, therefore, the particular water is prevented from reaching the outside of the air-conditioning casing 80.

### Third Embodiment

According to the first embodiment described above, the first peripheral end portion 60a and the second peripheral end portion 60b of the seal member 60 are formed progressively upward from the engine compartment to the passenger compartment between the engine compartment and the passenger compartment. Alternatively, according to the third embodiment, the seal member 60 is configured as described below.

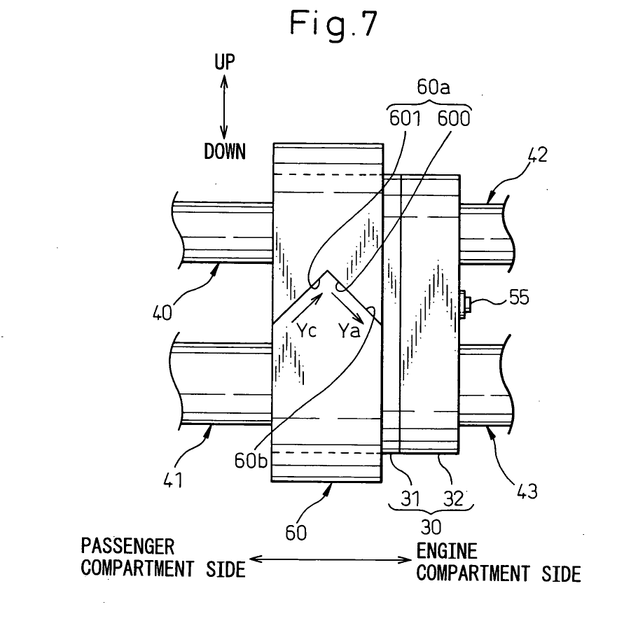

FIG. 7 shows a seal member 60 according to this embodiment. In FIG. 7, the same reference numerals as in FIG. 3 designate the same component parts, respectively, as those of FIG. 3, and are not described any further.

The first peripheral end portion 60a, as shown in FIG. 7, is composed of an inclined contact portion 600 in contact with the second peripheral end portion 60b along the diagonal direction Ya and an inclined contact portion 601 in contact with the second peripheral end portion 60b along the diagonal direction Yc progressively downward in the direction toward the passenger compartment.

### Fourth Embodiment

The third embodiment is described above with reference to a case in which the first peripheral end portion 60a of the seal member 60 is composed of the inclined contact portion 600 and the inclined contact portion 601. As an alternative, the seal member 60 according to the fourth embodiment is configured as described below.

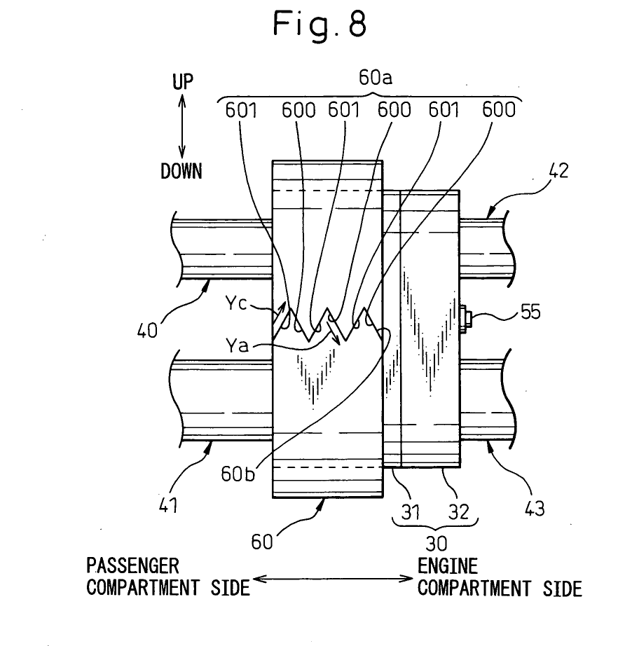

FIG. 8 shows a seal member 60 according to this embodiment. In FIG. 8, the same reference numerals as those in FIG. 3 designate the same component parts, respectively, and are not described any further. The first peripheral end portion 60a of the seal member 60 is composed of three inclined contact portions 600 and three inclined contact portions 601 arranged alternately with each other.

### Fifth Embodiment

The first embodiment is described above with reference to a case in which the first peripheral end portion 60a of the seal member 60 is formed progressively upward in the direction from the engine compartment to the passenger compartment. According to the fifth embodiment, the seal member 60 is alternatively configured as described below.

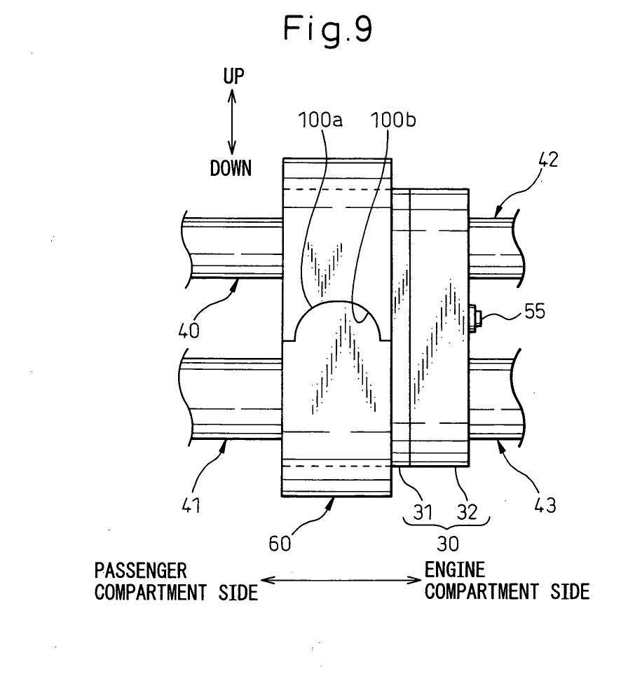

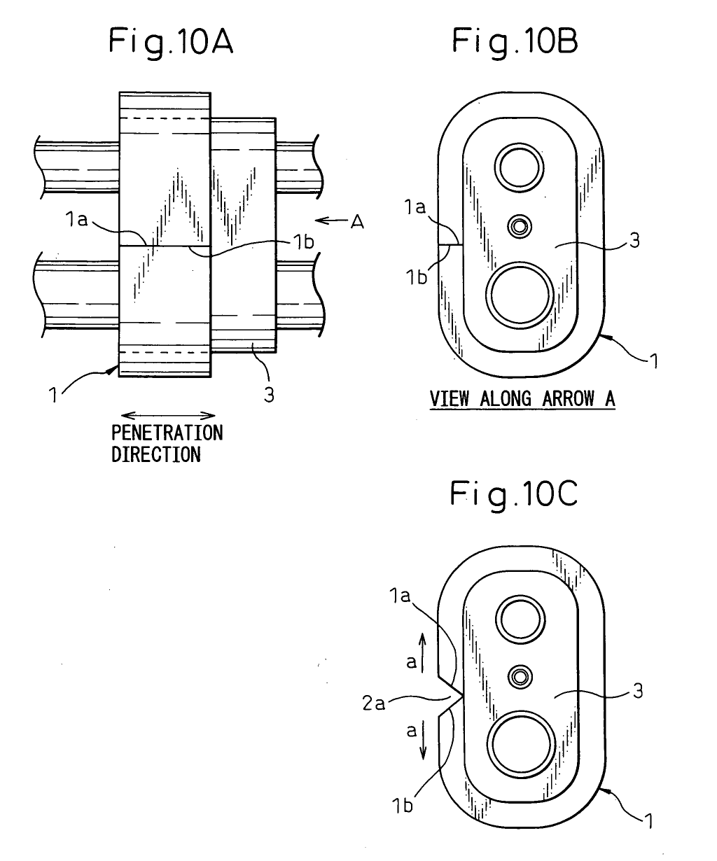

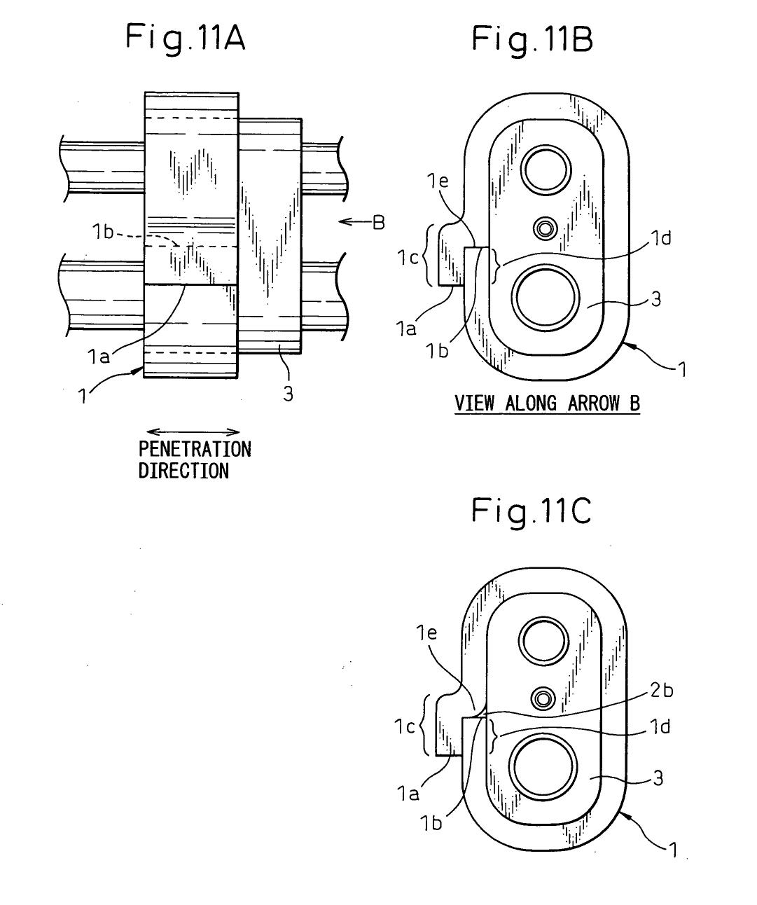

FIG. 9 shows a seal member 60 according to this embodiment. In FIG. 9, the same reference numerals as those in FIG. 3 designate the same component parts, respectively, and are not described any further.

The first peripheral end portion 100a of the seal member 60 is formed with an upwardly convex arc. The second peripheral end portion 100b is formed with a downwardly concave arc so that the first peripheral end portion 100a is fitted therein.

According to this embodiment, the first peripheral end portion 100a is formed as a semicircular protrusion, and the second peripheral end portion 100b as a semicircular depression.

In this embodiment having the aforementioned configuration, the first peripheral end portion 100a and the second peripheral end portion 100b of the seal member 60 are butted against each other at the time of inserting the joint member 30 and the seal member 60 into the through hole 12 of the casing 10.

As a result, a gap is difficult to form between the first peripheral end portion 100a and the second peripheral end portion 10b, and therefore the sealing performance in the through hole 12 of the casing 10 is improved.

According to this embodiment, the first peripheral end portion 100a is formed with an upwardly convex arc. The second peripheral end portion 100b is formed with a downwardly concave arc.

As a result, water which may intrude between the first peripheral end portion 100a and the second peripheral end portion 100b from the engine compartment is prevented from reaching the passenger compartment.

The second embodiment described above may employ the seal member 60 according to any one of the third, fourth and fifth embodiments.

The first to fifth embodiments are described above with reference to an application of the seal structure to the air conditioning system of the automotive vehicle. Nevertheless, the seal structure according to this invention is applicable also to various other devices with equal effect.

While the invention has been described by reference to specific embodiments chosen for purposes of illustration, it should be apparent that numerous modifications could be made thereto by those skilled in the art without departing from the basic concept and scope of the invention.

1. A seal structure comprising:
a casing having a through hole;
a joint member arranged through the through hole to connect a first air-conditioning unit inside the casing and a second air-conditioning unit outside the casing to each other thereby to form a fluid path between the first and second air-conditioning units; and
a band-shaped seal member wound around the joint member to seal a gap between the joint member and a hole-formed portion of the casing forming the through hole;
wherein a first peripheral end portion and a second peripheral end portion of the seal member are arranged in peripheral contact with each other;
wherein the seal member is formed in such a manner that the first peripheral end portion and the second peripheral end portion are in contact with each other along a first diagonal direction extending progressively upward along one direction of the through hole; and
wherein the joint member and the seal member are inserted into the through hole in such a manner that the first peripheral end portion and the second peripheral end portion are butted against each other.

2. The seal structure according to claim 1,
wherein the first peripheral end portion of the seal member includes a first contact portion in contact with the second peripheral end portion along the first diagonal direction and a second contact portion in contact with the second peripheral end portion along a second diagonal direction extending progressively downward in the one direction of the through hole.

3. The seal structure according to claim 2,
wherein the first peripheral end portion of the seal member has a plurality of the first contact portions and a plurality of the second contact portions, and
wherein the first peripheral end portion of the seal member is formed in such a manner that the first contact portions and the second contact portions are alternate with each other.

4. A seal structure comprising:
a casing having a through hole;
a joint member arranged through the through hole to connect a first air-conditioning unit inside the casing and a second air-conditioning unit outside the casing thereby to form a fluid path between the first and second air-conditioning units; and
a band-shaped seal member wound around the joint member to seal a gap between the joint member and a hole-formed portion of the casing forming the through hole;
wherein a first peripheral end portion and a second peripheral end portion of the seal member are arranged in contact with each other in the peripheral direction;
wherein the first peripheral end portion of the seal member is formed with a convex arc in the peripheral direction;
wherein the second peripheral end portion of the seal member is formed with a concave arc in the peripheral direction so that the first peripheral end portion is fitted therein; and
wherein the joint member and the seal member are inserted into the through hole in such a manner that the first peripheral end portion and the second peripheral end portion are butted against each other.

5. The seal structure according to claim 4,
wherein the first peripheral end portion of the seal member is formed as a semicircular protrusion toward the second peripheral end portion.

6. The seal structure according to claim 4,
wherein the casing is arranged in a through hole which is formed in a fire wall of the automotive vehicle between the engine compartment and the passenger compartment.

7. The seal structure according to claim 4,
wherein the casing accommodates a heat exchanger as the first air-conditioning unit while at the same time constituting an air-conditioning casing through which the air having exchanged heat in the heat exchanger flows.
